(19) United States
(12) Patent Application Publication
(10) Pub. No.: US 2015/0352014 A1
(43) Pub. Date: Dec. 10, 2015

(54) Jejunal Feeding Tube And Delivery System

(71) Applicant: GI DYNAMICS, INC., Lexington, MA (US)

(72) Inventors: Ronald B. Lamport, Pelham, NH (US); Keith S. Gersin, Charlotte, NC (US); Andy H. Levine, Newton, MA (US)

(21) Appl. No.: 14/759,345

(22) PCT Filed: Jan. 6, 2014
(86) PCT No.: PCT/US14/10298

§ 371 Date: Jul. 6, 2015

Related U.S. Application Data
(60) Provisional application No. 61/749,588, filed on Jan. 7, 2013.

(51) Int. Cl. A61J 15/00

(52) U.S. Cl. CPC A61J 15/0023; A61J 15/0003; A61J 15/0069; A61J 15/0073; A61J 15/0042; A61J 15/0061

(57) ABSTRACT

A delivery apparatus and related method for delivering a gastrointestinal device includes a gastrointestinal device (e.g., a delivery or feeding tube) having a lumen to provide a conduit into the digestive tract, from a location external to the digestive tract. The apparatus includes an inner shaft slidably disposed within the lumen of the gastrointestinal device. The shaft is configured to pass through a length of the intestines and to deliver the gastrointestinal device. An atraumatic element (e.g., a ball or balloon) is distal to and coupled to a distal tip of the inner shaft. The atraumatic element can be releasably coupled to the distal tip of the inner shaft. For example, the delivery apparatus can include a release mechanism that releasably engages the atraumatic element to retain the atraumatic element on the distal tip of the shaft. The gastrointestinal device can be configured to extend through and couple to a port, such as a percutaneous endoscopic gastrostomy (PEG) tube.

### RELATED APPLICATIONS

This application claims the benefit of U.S. Provisional Application No. 61/749,588 filed on Jan. 7, 2013. The entire teachings of the above application are incorporated herein by reference.

### BACKGROUND

Enteral feeding is required for patients who cannot feed themselves orally. Feeding may be directed directly into the stomach or intestines. By placing a tube into the distal duodenum or proximal jejunum, the risk and prevalence of bronchial aspiration of regurgitated food is greatly reduced as compared to gastric feeding. Jejunal feeding tubes (J-tubes) may be placed trans-oral or trans-nasal for short-term use, but more commonly and for long-term use are placed through a percutaneous endoscopic gastrostomy (PEG) tube or button.

Placing tubes through the stomach into the duodenum and jejunum is difficult. Typically, an endoscope is used to drag the J-tube with it into the intestine. However, as the endoscope is removed, the J-tube often drags back with it due to friction against the endoscope.

J-tubes are relatively simple single or double lumen, flexible, polyurethane or other polymer tubes. One lumen is used to pass the nutrition. The other lumen may be used to deflate the stomach of contents if it has trouble emptying. Such double lumen tubes are also referred to as GJ (Gastro-Jejunal) tubes.

Some J-tubes have a grasping element at their distal end (suture) so that the endoscopist can grab it with a grasper through the working channel of the endoscope to drag the J-tube distally. Once the J-tube is deployed, endoscopic clips are often used to anchor the tip of the J-tube to the mucosa of the jejunum while the endoscope is removed. The clip eventually falls off and passes. These clips are expensive (>$300) and unreliable and often the clip can fall off while the endoscope is being removed.

PEGs are marketed by a variety of companies including Cook, Bard and Boston Scientific. They come in 18, 20, 24 and 28 French (F) outer diameter sizes (French=3× outer diameter in mm) with 20 and 24 F being the most commonly used. A typical 20F PEG tube has an inner diameter of 0.165 inches (4.191 mm). For each 1F increase in outer diameter, the inner diameter may increase by about 1 mm. J-tubes are about 70 cm in length and 9F or 12F (3 mm or 4 mm) in outer diameter. The through lumens of J-tubes vary in diameter but appear to be about 2.5 mm.

What is needed is a better method of delivering feeding tubes into the distal duodenum and jejunum which makes placement fast, simple and which requires minimal skill.

### SUMMARY

Embodiments of the present invention relate to apparatus and methods for delivering a gastrointestinal device, such as a jejunal feeding tube (J-tube), into the digestive tract.

A delivery apparatus for delivering a gastrointestinal device includes a gastrointestinal device having a lumen to provide a conduit into the digestive tract, from a location external to the digestive tract, the device configured to extend through and couple to a port. The apparatus includes an inner shaft slidably disposed within the lumen of the gastrointestinal device. The shaft is configured to pass through a length of the intestines and to deliver the gastrointestinal device. An atraumatic element is distal to and coupled to a distal tip of the shaft.

In some embodiments, the atraumatic element is releasably coupled to the distal tip of the inner shaft. The delivery apparatus, e.g., the inner shaft, can include a release mechanism that releasably engages the atraumatic element to retain the atraumatic element on the distal tip of the shaft. The release mechanism can be configured to release the atraumatic element from the inner shaft and the release mechanism within the intestine. The atraumatic element can be remotely releasable, as described herein.

In some embodiments, the release mechanism includes a movable element, such as a wire, which may extend along a length of the inner shaft and which may be longitudinally movable within the inner shaft. The atraumatic element may be released from the distal tip of the shaft and the movable element by movement of the movable element, for example, by movement of the movable element away from the atraumatic element. The inner shaft can be a catheter having a lumen therein. In an embodiment, the moveable element extends along a first lumen in the inner shaft and a pusher wire extends along a second lumen in the shaft, the pusher wire being moveable to push the atraumatic element, once released, away from the distal tip of the inner shaft. In some embodiments, the atraumatic element is attached to a loop which is held by the release mechanism.

The inner shaft can include first and second holes near its distal tip. The moveable element can exit the shaft via the first hole and re-enter the shaft via the second hole, the moveable element extending between the first and second holes through a loop attached to the atraumatic element.

The inner shaft and gastrointestinal device can be disposed within an outer sheath or guide tube, which may be curved to facilitate placement of the apparatus in the stomach. The outer sheath guides the passage of the inner shaft and gastrointestinal device through a length of the stomach.

Components of the apparatus including the inner shaft, gastrointestinal device, and outer sheath and, in some embodiments, the atraumatic element, may be configured to pass through the port into the stomach. In certain embodiments, the port is a percutaneous port and may include a percutaneous endoscopic gastrostomy (PEG) tube.

The atraumatic element, which can be remotely releasable, may include a spherical element or a ball. The atraumatic element may be inflatable or include a hydrogel that expands in place in the stomach. The atraumatic element can be substantially larger in diameter than the inner shaft. For example, the atraumatic element can be about 4 mm to about 12 mm in diameter and the inner shaft can be about 2 mm to about 3 mm in diameter. The atraumatic element may be larger in diameter than 12 mm.

A method of delivering a gastrointestinal device includes passing an inner shaft through a port through a length of the intestines. The inner shaft has an atraumatic element distal to and coupled to a distal tip of the shaft. The method further includes advancing a gastrointestinal device over the inner shaft toward the distal tip of the inner shaft, withdrawing the inner shaft, and securing the gastrointestinal device to the port. The gastrointestinal device has a lumen to provide a conduit into the digestive tract from a location external to the digestive tract.

In certain embodiments, the inner shaft includes a release mechanism that releasably engages the atraumatic element to retain the atraumatic element on the distal tip of the shaft. The method can include releasing the atraumatic element from the inner shaft and the release mechanism within the intestines.

A delivery apparatus for delivering a delivery tube includes a delivery tube having a lumen to provide a conduit into the digestive tract from a location external to the digestive tract. The apparatus further includes an inner shaft slidably disposed within the lumen of the delivery tube and configured to pass through a length of the intestines and to deliver the delivery tube, an atraumatic element distal to and coupled to a distal tip of the shaft, and an outer sheath. Further, the inner shaft and delivery tube are disposed within the outer sheath.

A method of delivering a delivery tube includes passing an inner shaft through an outer sheath through a length of the intestines, the shaft having an atraumatic element distal to and coupled to a distal tip of the shaft. The method includes advancing a delivery tube over the inner shaft toward the distal tip of the inner shaft, the delivery tube having a lumen to provide a conduit into the digestive tract from a location external to the digestive tract. Further, the method includes withdrawing the inner shaft through the lumen of the delivery tube, and withdrawing the outer sheath.

The outer sheath may be configured for delivery through the mouth. The atraumatic element can be a spherical element, e.g., a ball, and may be inflatable and/or reversibly coupled to the distal tip of the shaft, as further described herein.

A delivery apparatus for delivering a gastrointestinal device includes a gastrointestinal device having a lumen to provide a conduit into the digestive tract from a location external to the digestive tract, and a stylet removably disposed within the lumen to guide passage of the gastrointestinal device through a length of the stomach. The apparatus includes an inner shaft that is extendable through the lumen of the gastrointestinal device when the stylet is removed, and that is configured to pass through a length of the intestines and to deliver the gastrointestinal device. Further, an atraumatic element is distal to and coupled to a distal tip of the shaft. The stylet may be curved to guide the gastrointestinal device toward the pylorus.

A method of delivering a gastrointestinal device includes passing a gastrointestinal device and a stylet through a length of the stomach, the gastrointestinal device having a lumen to provide a conduit into the digestive tract from a location external to the digestive tract, the stylet being removably disposed with the lumen. The method further includes removing the stylet and extending an inner shaft through the lumen of the gastrointestinal device through a length of the intestines, the shaft having an atraumatic element distal to and coupled to a distal tip of the shaft. Further, the method includes advancing a gastrointestinal device over the inner shaft toward the distal tip of the inner shaft and withdrawing the inner shaft.

Delivery apparatus and methods according to embodiments of the present invention offer many advantages. For example, the inner catheter and the gastrointestinal device, e.g., a jejunal feeding tube or other delivery tube, can be advanced into the stomach and into the intestines without the use of an endoscope. A traditional device includes a loop at the end of a J-tube that a physician grasps with the aid of an endoscope to drag the J-tube down into the intestine. Furthermore, in traditional delivery systems clips are used to keep the J-tube from coming back out of the intestine when the endoscope is withdrawn. Because embodiments of the present invention do not require the use of an endoscope, the risk of pulling the jejunal tube out after delivery is reduced, so the use of clips, which are expensive and can cause trauma to the intestinal tissue, can be avoided. Furthermore, embodiments of the present invention enable deployment of a jejunal feeding tube that is longer and that extends further into the intestine than conventional jejunal feeding tubes. Typical J-tubes are 70 cm in length, but embodiments discussed herein can deploy J-tubes that are 90 cm or longer. Further yet, embodiments of the present invention can include a curved outer sheath or guide tube. The guide tube enables placement of the inner shaft and gastrointestinal device in the stomach near the opening of the pylorus without the need to visualize placement of the device with an endoscope. An endoscope, however, may be used to aim the guide tube and inner shaft if desired. Instead of a guide tube, embodiments can include a stylet that is removably disposed within the lumen of the delivery tube.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a perspective view of a delivery apparatus according to an embodiment of the present invention.

FIG. 2 is a cross-sectional view of an inner catheter of a delivery apparatus according to an embodiment of the present invention.

FIG. 3A illustrates an atraumatic element releasably coupled to a distal tip of a shaft.

FIG. 3B illustrates an atraumatic element released from the inner shaft.

FIGS. 4A-4F are sectional views of a portion of the digestive tract in a body illustrating delivery of the gastrointestinal device into the intestine.

FIG. 5 is a side view of another example of a delivery apparatus including a J-tube and a releasable ball or balloon as an atraumatic element.

FIG. 6A is a cross-sectional view of an example balloon delivery system showing the balloon deflated.

FIG. 6B is a cross-sectional view of the balloon delivery system of FIG. 6A showing the balloon inflated.

FIG. 7A illustrates a delivery system including a GI tube and an inner catheter with a balloon tip for delivery through a PEG tube.

FIG. 7B illustrates the delivery system of FIG. 7A inserted through the PEG tube and with the balloon inflated.

FIG. 8 is a perspective view of a delivery system including a releasable ball tipped catheter that can be pre-loaded within a custom naso-gastric (NG) tube for delivery through the mouth.

FIGS. 9A-9E illustrate delivery of an NG tube through the mouth according to an embodiment of the present invention.

FIGS. 10A-10C illustrate delivery through a percutaneous port using a stylet.

### DETAILED DESCRIPTION OF THE INVENTION

A description of example embodiments of the invention follows.

The teachings of all patents, published applications and references cited herein are incorporated by reference in their entirety.

Delivery apparatus and methods for delivering a gastrointestinal implant using an atraumatic element, including a releasable atraumatic ball or an inflatable balloon, are described in U.S. Pat. Nos. 7,122,058 and 7,837,643, which are incorporated herein by reference in their entirety.

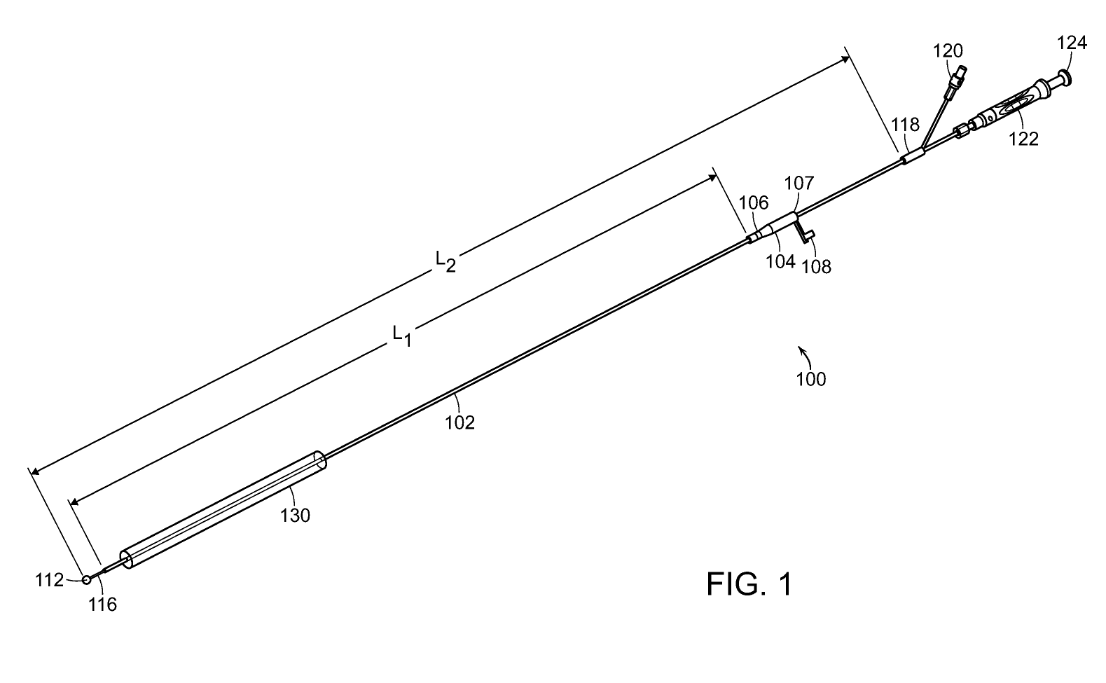

FIG. 1 shows a delivery apparatus 100 suitable for delivering a gastrointestinal device into a digestive tract. The delivery apparatus 100 includes a gastrointestinal device 102 and an inner shaft 110 that is slidably disposed within a lumen of the gastric intestinal device 102. Inner shaft or delivery catheter 110 is configured to pass through a length of the intestines and to deliver the gastrointestinal device 102. In the embodiment shown, the inner shaft 110 extends from a proximal end 118 to a distal end 116 for a length of L2. The gastrointestinal device 102 extends from a proximal end to a distal end for a length L1. In one embodiment, the inner shaft 110 is a catheter that has an outer diameter of 2.0 mm and the gastrointestinal device 102 is a tube having an outer diameter of 3.9 mm and an inner diameter of 2.3 mm. As shown in FIG. 1, the length L1 of gastrointestinal device 102 may be 31 inches and the length L2 of inner shaft 110 may be 40 inches. Other lengths and diameters are possible and may be selected according to a particular application and/or mode of delivery (e.g., oral, nasal, through percutaneous port) of the device.

Gastrointestinal device 102 may be a jejunal feeding tube (J-tube) that has a lumen for providing a conduit into the digestive tract from the location external to the digestive tract. Typically, the device 102 is configured to extend through and couple to a port, such as a percutaneous endoscopic gastrostomy (PEG) tube. At its proximal end, gastrointestinal device 102 includes an adapter 104 having a port 107 and a coupling 106 for coupling to the percutaneous port. The coupling 106 can be a standard coupling and may be configured to secure the device 102 to the percutaneous port via a friction fit, taper fit, snap-fit or other means known in the art. The adapter 104 can be configured to receive a tip of a standard syringe through port 107. A cap or closure 108 can selectively close port 107.

Gastrointestinal device 102 may include additional ports. For example, device 102 can include a Y connector that is placeable in the digestive tract through a PEG tube. The Y connector can include one port (J-tube port) for providing a fluid conduit into the intestines and another port (G-tube port) for providing a fluid conduit into the stomach.

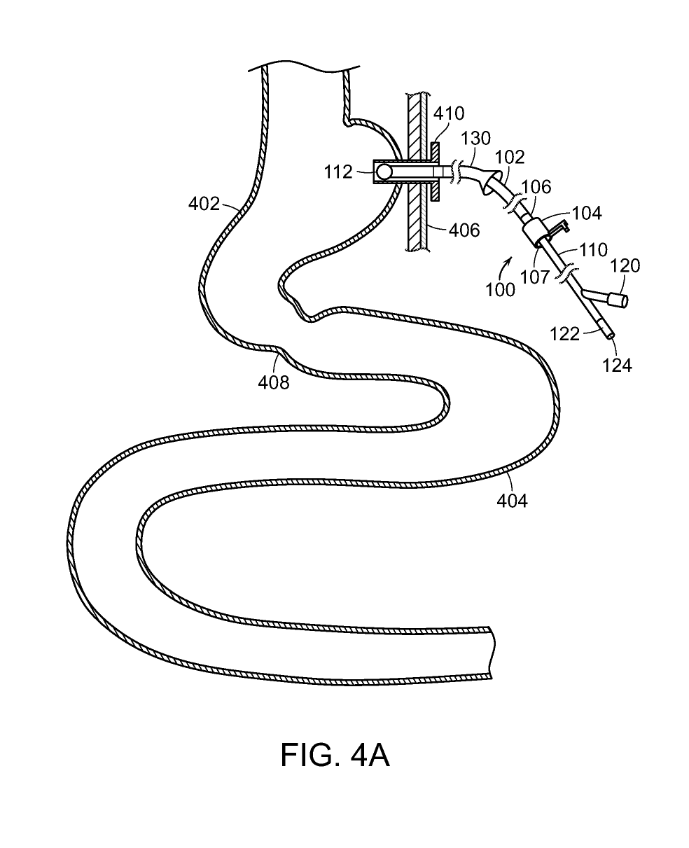

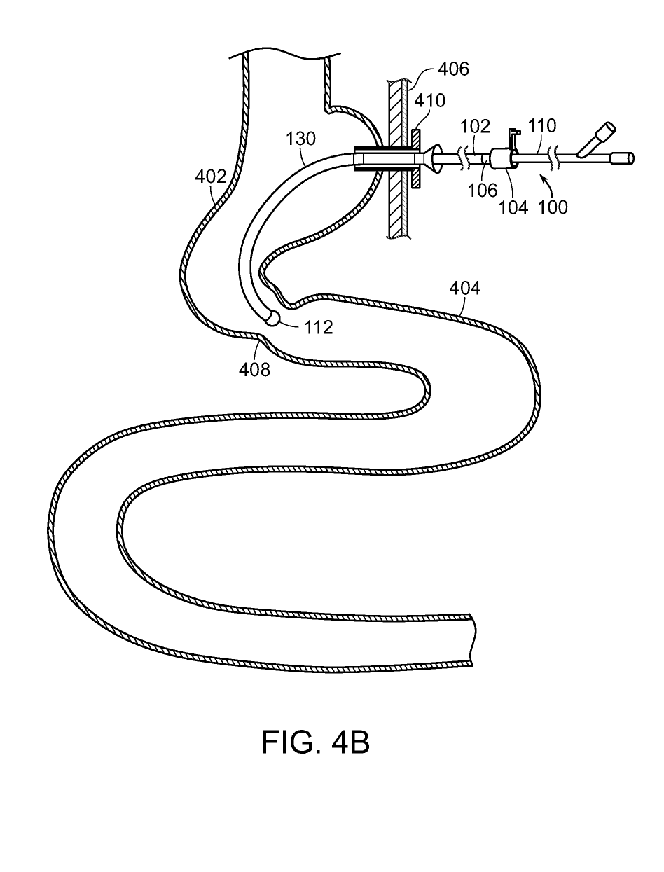

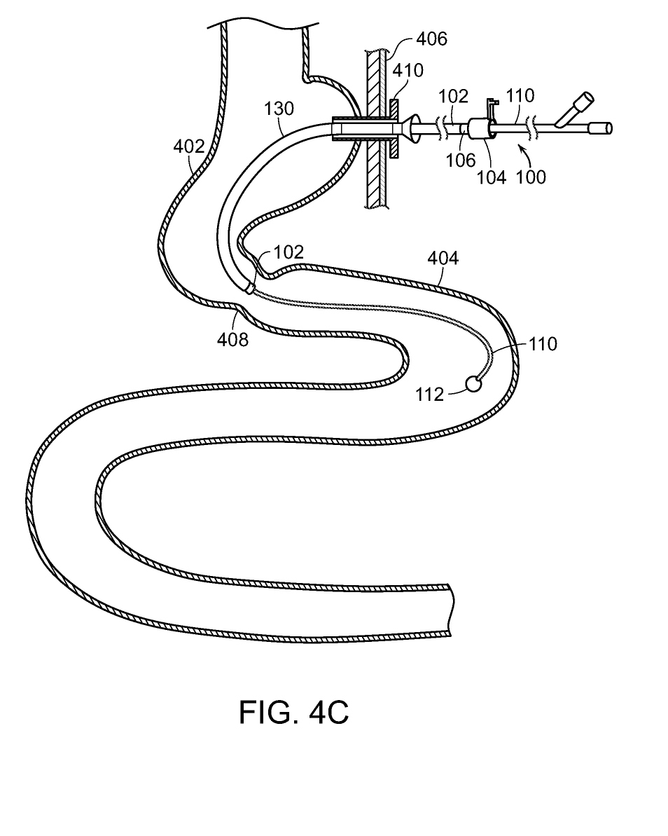

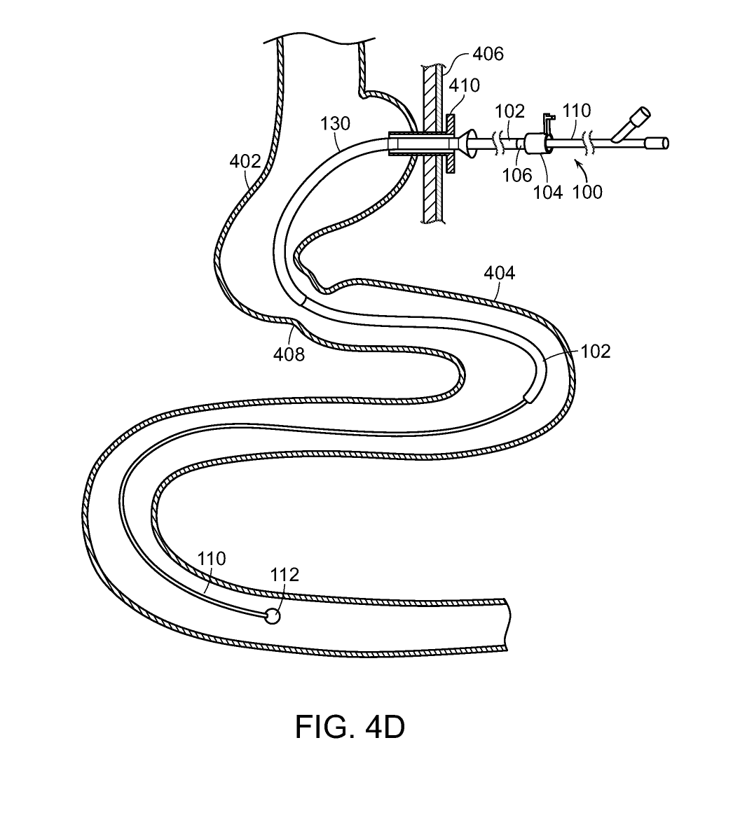

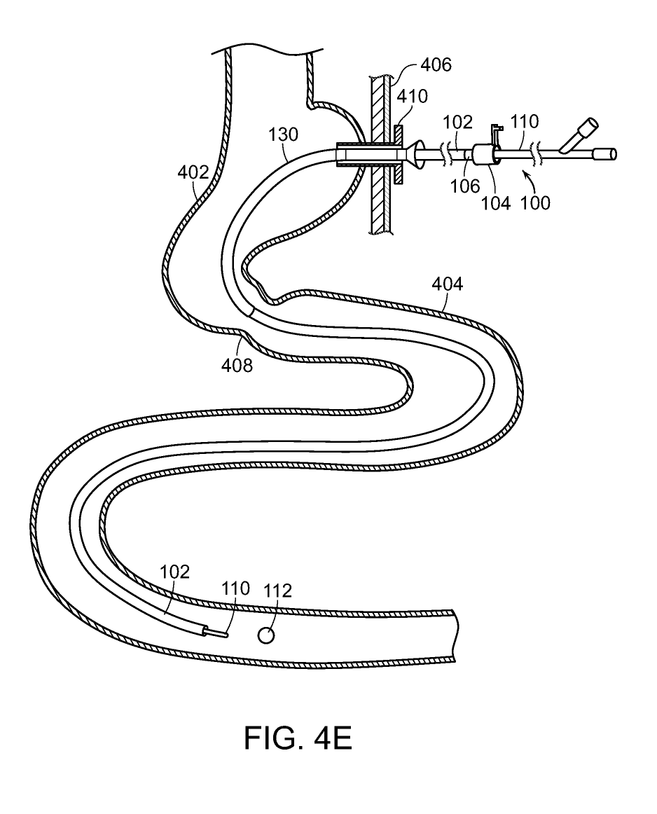

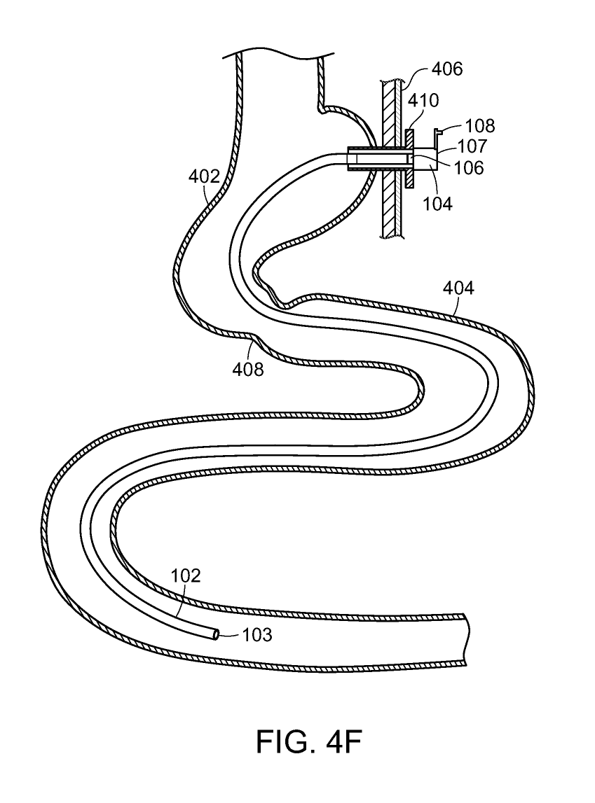

The apparatus 100 may also include an outer sheath or guide tube 130, which will be described later in conjunction with FIG. 4. The outer sheath or guide tube 130 is schematically illustrated in FIG. 1 as a straight tube. As shown in FIG. 4, the outer sheath or guide tube 130 may be curved to facilitate placement of the gastrointestinal device 102.

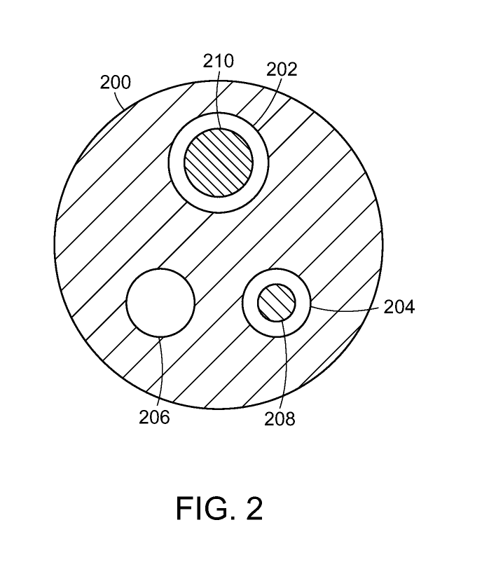

As shown in FIG. 1, the delivery apparatus 100 includes an atraumatic element 112 that is distal to and releasably coupled to a distal tip 116 of inner shaft 110. Delivery apparatus 100 also includes a release mechanism that releasably engages atraumatic element 112 to retain the atraumatic element on the distal tip on 16 of shaft 102. The release mechanism may be a mechanical, pneumatic, magnetic, or other suitable mechanism. As shown in FIG. 1, the release mechanism can include a movable element or locking wire 120. Movement of the movable element 120 releases the atraumatic element 112 from the distal tip 116 of shaft 110. The movable element 120 extends along the length of shaft 110 and is longitudinally movable within the inner shaft 110. Movable element 120 enables atraumatic element 112 to be remotely releasable, for example, after the gastrointestinal device 102 has been positioned at a desired location within the gastrointestinal tract. In some embodiments, atraumatic element 112 is released by movement of the movable element 120 away from the atraumatic element 112. Movable element 120 can extend along a first lumen in inner shaft 110 and a pusher wire 124 can extend along a second lumen in shaft 110 (see also FIG. 2). The pusher wire 124 is movable to push the atraumatic element 112, once released, away from the distal tip 116 of the inner shaft 110. Pusher wire 124 may extend through a handle 122 at the proximal end 118 of inner shaft 110, as shown in FIG. 1.

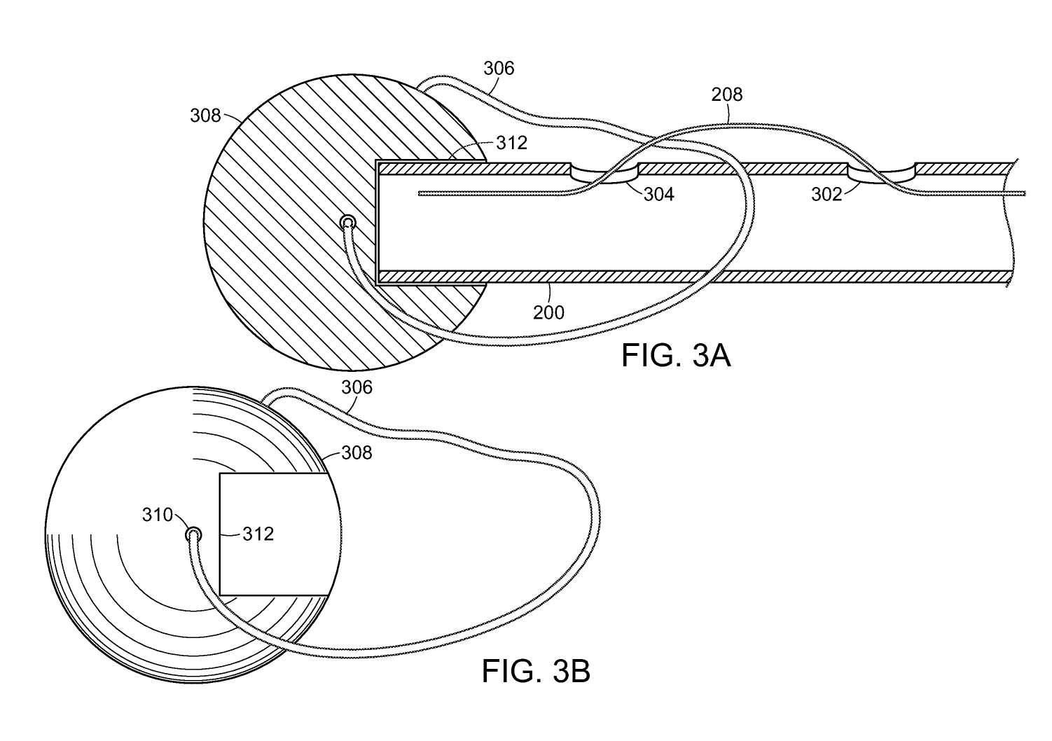

As shown in FIG. 1, the distal end of a shaft 110 terminates with a spherical shaped element 112 that is solid or inflatable and forms an atraumatic tip. In the embodiment shown, the spherical shaped element is a solid ball, which provides an atraumatic, leading tip to delivery apparatus 100, such that the apparatus follows the contour of the intestines. In the embodiment shown, the outer diameter of the ball is about 7.5 mm; however, the range of diameters can be about 4 mm to about 12 mm. Diameters larger than 12 mm may be used. The atraumatic element 112 at the end of shaft 110 is held onto the shaft with locking wire 120 maintaining tension on the atraumatic element 112, which will be described later in conjunction with FIG. 3A.

In some embodiments, the atraumatic element 112 is inflatable, e.g., a balloon. The inflatable atraumatic element may be releasably coupled to the distal tip of the inner shaft 110. In a deflated state, the element 112 can pass through the inner diameter of gastroinestinal device (J-tube) 102. In its inflated state, the atraumatic element or balloon permits guidance of the delivery apparatus 100 through the digestive tract. After placement of the gastrointestinal device 102 in the digestive tract, the inflatable atraumatic element 112 can be deflated and removed with the delivery catheter 110. In one embodiment, the atraumatic element 112 includes a hydrogel that expands in place in the stomach. Prior to delivery of the apparatus 100, the hydrogel, in its unexpanded state, allows the atraumatic element 112 to pass through the inner diameter of tube 102.

FIG. 2 is a cross-sectional view of an inner shaft 200 of a delivery apparatus, such as delivery apparatus 100 shown in FIG. 1. The inner shaft outer diameter is preferably less than 0.10 inches, or preferably less than 2.54 mm. In one embodiment, the inner shaft 200 is a 3-lumen extrusion of PEBAX® 7233 (a thermoplastic elastomer made of flexible polyether and rigid polyamide) with an outer diameter of 0.090 inches and round inner lumens 202, 204, 206 having respective diameters of 0.040 inches, 0.020 inches and 0.020 inches. This material is selected to maintain a low profile, a small minimum bend radius that is less than 0.5 inches without kinking, a good column strength when fortified with an inner guide wire or stiffening wire, and a low coefficient of friction, preferably less than 0.4, in a material with good thermoplastic and bonding properties. A first lumen 204 is used to pass a moving element 208, such as a locking wire, along a length of shaft 200 to the distal end of the delivery device. The locking wire 208 is used to hold the atraumatic element at a distal tip of inner shaft 200. A second lumen 202 is used to pass a spring guide or stiffening wire 210 through shaft 200 to increase the rigidity of the shaft during introduction of the shaft into the intestines. Stiffening wire 210 can be used as a pusher wire that is movable within lumen 202 to push the atraumatic element, once released, away from the distal tip of inner shaft 200. In the embodiment shown, the diameter of inner shaft 200 is 0.090 inches, the diameter of stiffening wire 210 is 0.035 inches, and the diameter of locking wire 208 is 0.015 inches. A third lumen 206 may be provided for other uses.

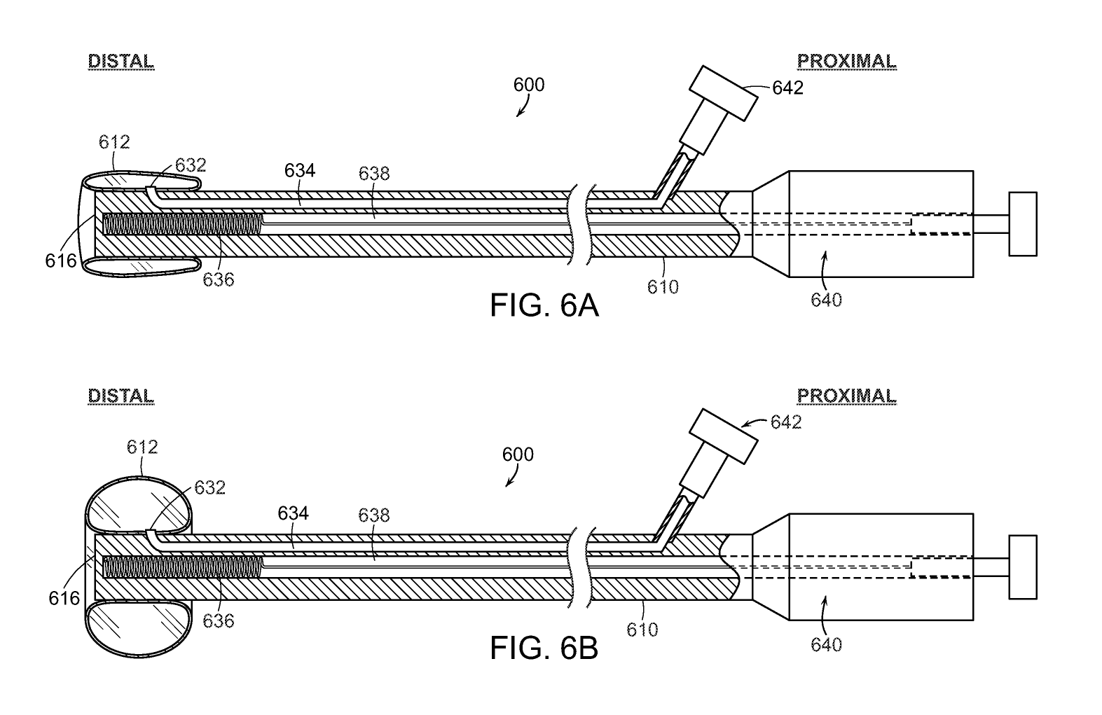

In embodiments that include an inflatable atraumatic element (e.g., a balloon), lumen 206 of inner shaft 200 can be used to transfer fluid into and out of the inflatable atraumatic element to inflate and deflate the atraumatic element. A delivery system that includes an inflatable balloon is illustrated in FIGS. 6A-6B.

FIGS. 3A-3B illustrate embodiments for attaching a releasable spherical shaped element to the distal end of an inner catheter. FIG. 3A is a detailed view of the distal end of the delivery system illustrating a releasable ball mechanism. A movable element or locking wire 208 travels through a first lumen 204 in inner shaft 200, exits the first lumen 204 (FIG. 2) through a proximal skive hole 302 and reenters the first lumen through a distal skive hole 304. A loop or suture 306 is attached to ball 308. The loop or suture 306 is looped through a locking wire 208 to hold the ball 308 at a distal end of the inner shaft 200 of the delivery apparatus. The ball 308 is released by pulling back on the locking wire 208 until the loop or suture 306 is no longer held by the locking wire 208. The ball 308 then falls off the distal end of the inner shaft 200 and exits the body through normal peristalsis through the intestines.

FIG. 3B illustrates the ball 308 released from the distal end of the inner shaft 200. The ball 308 includes a feed hole 310 through which the loop or suture 306 is attached to the ball 308. The ball 308 also includes a blind hole or recess 312 into which the inner catheter or shaft 200 fits, as illustrated in FIG. 3A.

FIGS. 4A-4F illustrate delivery of the gastrointestinal device using the delivery apparatus described in conjunction with FIG. 1. FIG. 4A shows a sectional view of a portion of the digestive tract illustrating the position of the distal end of delivery apparatus 100 in a percutaneous port 410. The inner shaft 110 is slidably disposed within the gastrointestinal device 102, and both are passed through the percutaneous port 410 into the stomach 402. The inner shaft 110 and the gastrointestinal device 102 are disposed within the curved outer sheath 130. The outer sheath 130 guides the passage of the inner shaft 110 and gastrointestinal device 102 through a length of the stomach 402. As shown, the inner shaft 110, gastrointestinal device 102, outer sheath 130, and atraumatic element 112 are configured to pass through percutaneous port 410 into the stomach 402. In this example, the percutaneous port 410 is a percutaneous endoscopic gastrostomy (PEG) tube that extends through skin 406 into stomach 402. The outer sheath 130 increases stability of the stomach portion of the gastrointestinal device 102 to increase pushability of the gastrointestinal device into the intestine. The outer sheath 130 can be propylene or other stiff material. The outer diameter of the outer sheath 130 can be sized to be less than the inner diameter of the PEG tube so that the outer sheath passes through the lumen in the PEG tube.

As shown in FIG. 4C, the outer sheath 130 has been advanced close to the pylorus 408. Inner catheter or shaft 110 is advanced through outer sheath 130 into the intestine 404 to a desired location, such as the jejunum. As shown in FIG. 4D, the gastrointestinal device 102 is then advanced over the inner shaft 110 toward the distal tip of the inner shaft. The gastrointestinal device 102 may also be advanced together with the inner shaft 110 into the intestine. The atraumatic element 112 at the end of inner shaft 110 provides an atraumatic leading tip to the inner shaft such that the shaft follows the contour of the intestine 404. A release mechanism releasably engages the atraumatic element 112 to retain the atraumatic element on the distal tip of inner shaft 110 during delivery of gastrointestinal device 102. Release mechanisms have already been described with reference to FIGS. 1-3A.

Once the delivery apparatus 100 with gastrointestinal device 102 is positioned within the intestine at a desired location, the atraumatic element 112 is released from inner shaft 110 and from the release mechanism, and the inner shaft 110 is withdrawn through the gastrointestinal device 102, as illustrated in FIG. 4E. The outer sheath 130 may then be removed from the gastrointestinal device 102. For example, the outer sheath 130 may be split—torn and removed through percutaneous port 410. The gastrointestinal device 102 is secured to the percutaneous port 410, for example, through a coupling 106, as shown in FIG. 4F. The coupling 106 can be a standard coupling and may couple to port 410 via a friction fit. After placement of the gastrointestinal device 102, port 107 of adapter 104 of the gastrointestinal device 102 is located externally to the digestive tract. A lumen extends from port 107 through the gastrointestinal device 102 to one or more openings 103 at or near the distal end of device 102. The lumen 107 provides a conduit into the digestive tract.

An endoscope (not shown) may be used to place the outer sheath 130, gastrointestinal device 102, and inner shaft 110 within the stomach and near the pylorus 408. In some embodiments, the gastrointestinal device 102, atraumatic element 112, or both, include radio opaque markings, in which case delivery of the device 102 can be accomplished under fluoroscopy and without the use of an endoscope.

In some embodiments, outer sheath (stiffening tube) 130 may be kept in the stomach after placement of the gastrointestinal device 102. For example the outer sheath or stiffening tube 130 may be formed integrally with the gastrointestinal device 102.

Example J-Tube Delivery System

Delivery of the J-tube is enabled by using a modified ENDOBARRIER® delivery system (U.S. Pat. Nos. 7,122,058 and 7,837,643, incorporated herein by reference) to guide the J-tube through the bowel. An inner catheter and stiffening wire are sized to pass through the J-tube inner lumen, which is roughly 2 mm diameter, but may vary by J-tube manufacturer. A special J-tube may be fabricated to make all dimensions work well together. The current ENDOBARRIER® inner catheter has a 2.0 mm outer diameter (OD).

A stiffening sheath is placed over the J-tube. This thin sheath provides stability of the stomach portion of the J-tube to increase pushability of the J-tube into the intestine. The sheath is polypropylene or other stiff material and is sized so that it passes through the lumen of the PEG tube through which the J-tube is to be delivered. In the example, the outer diameter of the sheath is less than 7 mm.

Once the inner catheter or shaft is passed through the J-tube lumen, a distal guiding ball (atraumatic element) is releasably attached to the inner catheter using the stiffening wire as a dead bolt. The distal ball is sized to be less than the inner diameter of the PEG tube, for example less than 7 mm in diameter, such that the ball will pass through the lumen of the PEG tube being used. Again, a custom PEG tube may be provided to ensure that the lumen of the PEG tube is large enough to pass the distal ball. However, standard PEG tubes exist with lumens of sufficient size.

In use, the assembled J-tube, inner catheter and stiffening sheath are advanced through the pre-existing PEG tube into the stomach of the patient (see also FIGS. 4A-4B). An endoscope is placed into the stomach through the patient's mouth. The stiffening sheath is advanced close to the pylorus under endoscopic visualization. Then, the inner catheter and J-tube are advanced through the pylorus with the distal ball leading. The J-tube and inner catheter are advanced to the appropriate length. The distal ball is then released and the inner catheter and stiffening sheath are removed through the PEG tube. A fluid fitting is then attached to the J-tube.

Pre-clinical Testing

Proof-of-concept testing was performed in an acute animal (porcine). Testing was performed to demonstrate that a 6.7 mm diameter distal tracking ball (atraumatic element) can negotiate safely and easily through the intestine. The standard ENDOBARRIER® liner delivery system uses a 12.5 mm diameter atraumatic ball to cover the distal opening of a capsule containing the intestinal liner.

A modified ENDOBARRIER® delivery system (GI Dynamics, Lexington, Mass.) was fabricated to allow delivery of the inner catheter with a 6.7 mm ball mounted on its distal end into the porcine intestines. Delivery of about 90 cm of the modified inner catheter was easily attained, more than enough to enable delivery of J-tubes which are around 70 cm in length. The distal ball was releasably coupled to distal end of inner catheter via a release mechanism as described above in reference to FIGS. 3A-3B.

Additional variations of the above design may include but are not limited to the following:
a) In the above-described design, the atraumatic ball may not fit through the lumen of the J-tube. Therefore, the J-tube and inner catheter may be assembled in-house and sold as a kit. It may be desirable to make the ball fit through any J-tube, so that the inner catheter can be used with any J-tube. One means of accomplishing this is to replace the atraumatic ball with a balloon whose deflated profile will permit it to pass through the inner diameter of the J-tube. Once the balloon is in the stomach, it can be inflated to permit guidance. Once the J-tube is delivered, the balloon is deflated and removed with the catheter. FIGS. 6A and 6B illustrate a suitable balloon delivery system.
b) The delivery apparatus can include a mechanism that permits attachment of the ball to the inner catheter after entry into the stomach, or in the field, onto any manufacturer's J-tube. Again, this makes it easier to fit all existing PEGs and J-tubes on the market.
c) The atraumatic ball may include a hydrogel that expands in place in the stomach, which would also eliminate the need to back load the inner catheter.
d) A custom J-tube with side rails which can ride over the inner catheter after the inner catheter is placed with a scope through the mouth.
e) Embodiments of the disclosed delivery device may be used for chronic drug delivery directly into the distal jejunum and ileum for treatment of intestinal diseases or disorders, including:
   i. Crohn's disease: Steroids
   ii. Obesity: Glucagon-like peptide-1 (GLP-1), bile acids, Cholecystokinin (CCK)
   iii. Diabetes: GLP-1, bile acids, CCK
   iv. Inflammatory bowel disease (IBD): Steroids
   v. Motility disorders: Cholinergic agonists, prokinetic agents, opioid antagonists, antidiarrheals, and antibiotics

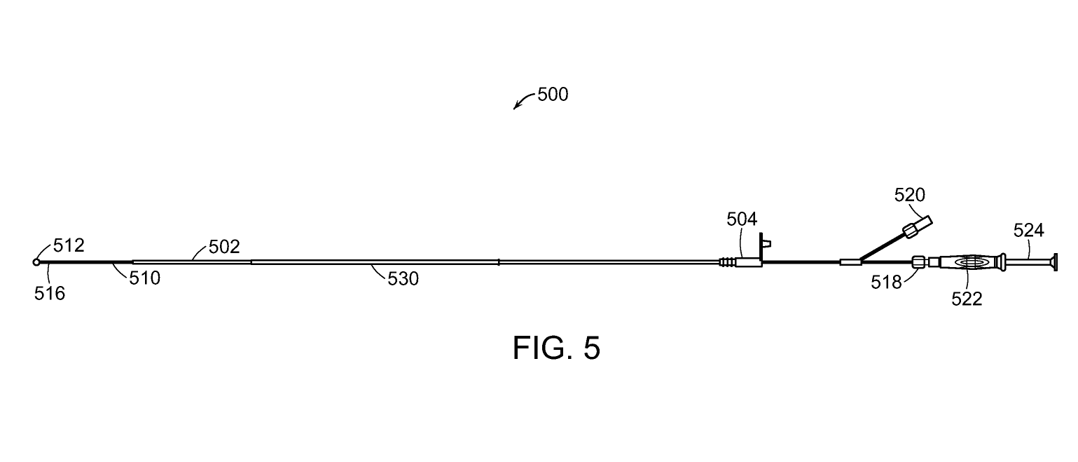

FIG. 5 is a side view of another example of a delivery apparatus 500 including a J-tube and a detachable ball or balloon as an atraumatic element. The delivery apparatus 500 is similar to apparatus 100 described above in reference to FIG. 1. As shown in FIG. 5, the delivery apparatus 500 includes an inner catheter or shaft 510 having an outer diameter in the range from about 0.080 inches to about 0.090 inches. A tracking ball 512 having an outer diameter of 0.200 inches is distal to and releasably coupled to the distal end 516 of the inner shaft 510. The ball 512 is configured to fit through a 24 French (F) PEG tube. The apparatus includes a release mechanism to releasably secure the distal ball to the inner catheter. As shown, the release mechanism includes a locking wire. The distal ball 512 is remotely releasable via the locking wire 520, which can be operated from the proximal end of the apparatus. Also included is a tracking ball pusher, including handle 522 and pusher wire 524, to push the ball 512 away from the distal tip 516 of the inner catheter 510 after release of the ball.

Instead of the ball of FIG. 5, a balloon may be used as the atraumatic element. The balloon should be sized to fit through the 24 F PEG tube in the deflated state. The balloon may have a larger outer diameter when inflated.

Referring to the embodiment shown in FIG. 5, the inner catheter is disposed in a gastro-jejunal tube (GJ-tube) 502 having an inner diameter of about 0.110 inches and an outer diameter of about 0.150 inches. The GJ-tube includes a cap 504 at its proximal end. The GJ-tube 502 and inner catheter 510 are disposed in an introducer or outer sheath 530. In FIG. 5, the introducer 530 appears as a straight tube. However, it should be understood that the introducer can be curved, e.g., curved along a length of the introducer as described elsewhere herein. As shown, the introducer 530 is a peel away introducer that has an inner diameter of about 0.170 inches and an outer diameter of about 0.200 inches.

FIGS. 6A-6B are sectional views of a balloon delivery system 600 including a delivery catheter (inner shaft) 610 fitted with a low profiled balloon 612. As shown in FIG. 6A, an inflatable spherical element, e.g., balloon 612, is coupled to the distal end 616 of inner shaft 610. One or more filling holes 632 connect to an inner lumen 634 of the catheter (inner shaft) to provide a fluid passage to a port 642 for inflation of the balloon 612. The balloon can be polyurethane or silicone. A stiffening wire or spring 636 can be passed through another lumen 638 (FIG. 6B) in the inner shaft 610 to provide additional stability and stiffness for passage through the gastrointestinal tract. The proximal end of the stiffening spring 636 includes a plunger 640 which can be used to insert and withdraw the stiffening spring.

FIG. 6B is a sectional view of the balloon delivery system 600 of FIG. 6A after the balloon 612 has been inflated. The balloon is expanded, e.g., inflated, by fluid, which flows through lumen 634 in the inner shaft and enters the balloon 612 through one or more fluid passages 632. As shown, the balloon 612 can be inflated to a diameter of about 12 mm.

Scenario 1: Using a GI Dynamics Delivery System in a Presently Marketed GJ Feeding Tube Through a PEG Tube (GJ—Gastro-Jejunal)

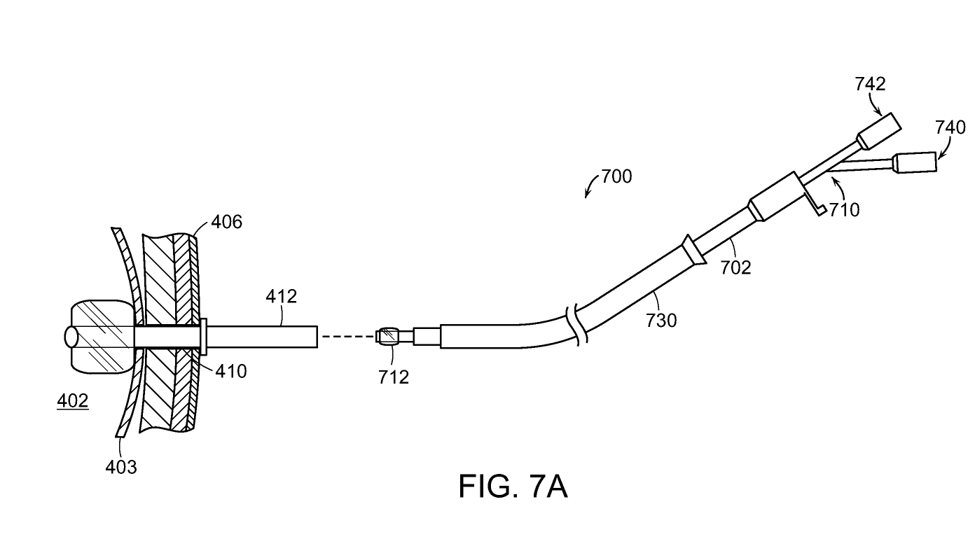

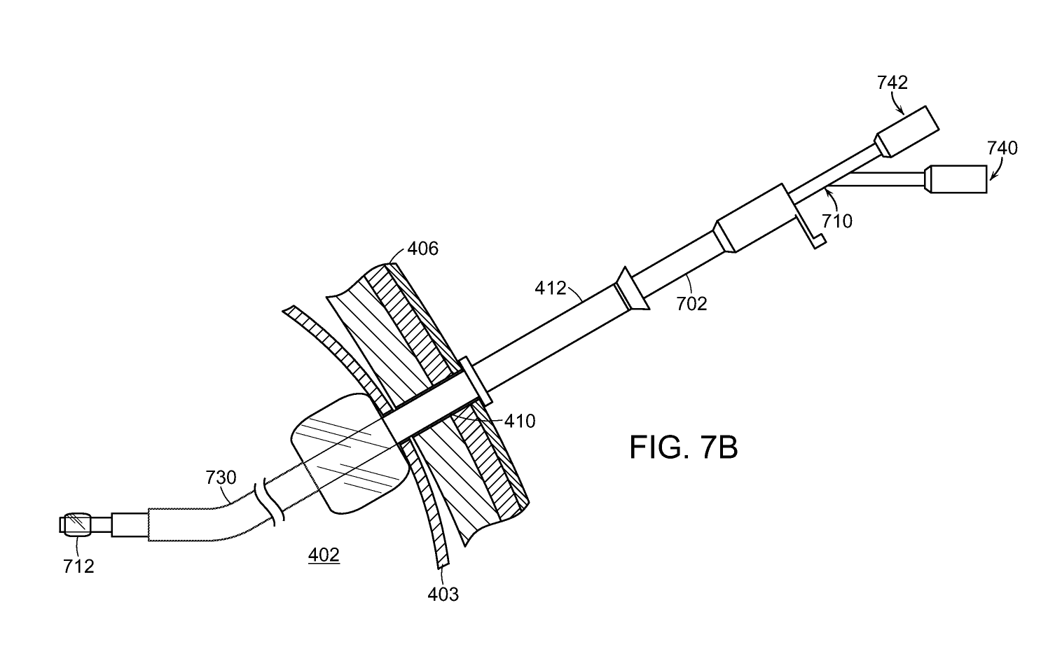

One can use a GI Dynamics delivery system (inner catheter 710 with a balloon tip 712) and place it through the center of a GJ tube 702 as illustrated in FIG. 7A. A curved, peel away introducer or outer sheath 730 can be slid over the GJ tube 702. The assembly 700 is then inserted through a percutaneous port 410, i.e., PEG tube 412, into stomach 402. As shown, a standard PEG tube may have an inner diameter of about 4.25 mm and can include an inflatable portion that secures the PEG tube against the stomach wall 403. With the balloon 712 deflated, the balloon tipped delivery system can fit through the PEG tube 412. Using the curved introducer 730, the system is steered towards the pylorus under endoscopic visualization until the distal tip of the system is, for example, within the bulbous duodenum. The delivery system includes a port 742 for passing a fluid through a lumen in inner catheter 710 to inflate balloon 712. The system can also include a port 740, including a plunger, to advance a stiffening wire through another lumen in the inner catheter 710. Example multi-lumen catheters are described herein in reference to FIGS. 2 and 6B.

As shown in FIG. 7B, the balloon 712 can be inflated once the delivery system is inserted through the PEG tube 412 into the stomach 402, although it may be appropriate to steer the system towards the pylorus, and possibly through the pylorus and into the duodenal bulb, prior to inflating the balloon. With the balloon 712 inflated, the delivery system is advanced through the intestine similar to a standard GI Dynamics delivery system. In this scenario, a balloon tipped delivery system is suitable because it can fit through a presently marketed GJ tube. In order to use a releasable ball system, the releasable ball can be coupled to the delivery system after the delivery system is placed through the PEG tube 412. Alternatively, the releasable ball can have an outer diameter (OD) that is smaller than the inner diameter (ID) of the PEG tube.

Scenario 2: Using a GI Dynamics Delivery System in a Custom Designed GJ Feeding Tube Through a PEG Tube

One can use a GI Dynamics delivery system (with a balloon tip or releasable ball tip) and place it through a lumen of a custom designed GJ tube. The delivery system can be preloaded within the GJ tube. The assembly can then be inserted through a PEG tube and, using a curved introducer, steered towards the pylorus similarly to the delivery system 700 illustrated in FIGS. 7A and 7B. The PEG tube can be a custom designed PEG tube, and the delivery system may be preloaded in the PEG tube. For example, the PEG tube can be custom designed to have an inner diameter of about 5 mm. The insertion of the delivery system may be visualized with an endoscope. The balloon can be inflated and the system can be advanced through the intestine similar to a standard GI Dynamics delivery system. Additionally, because the system can be preloaded because of its custom design, one can use a system similar to the present GI Dynamics delivery system with a releasable ball as long as the ball OD is smaller than the PEG tube ID.

Scenario 3: Custom NG Tube Delivery System (NG=Naso Gastric)

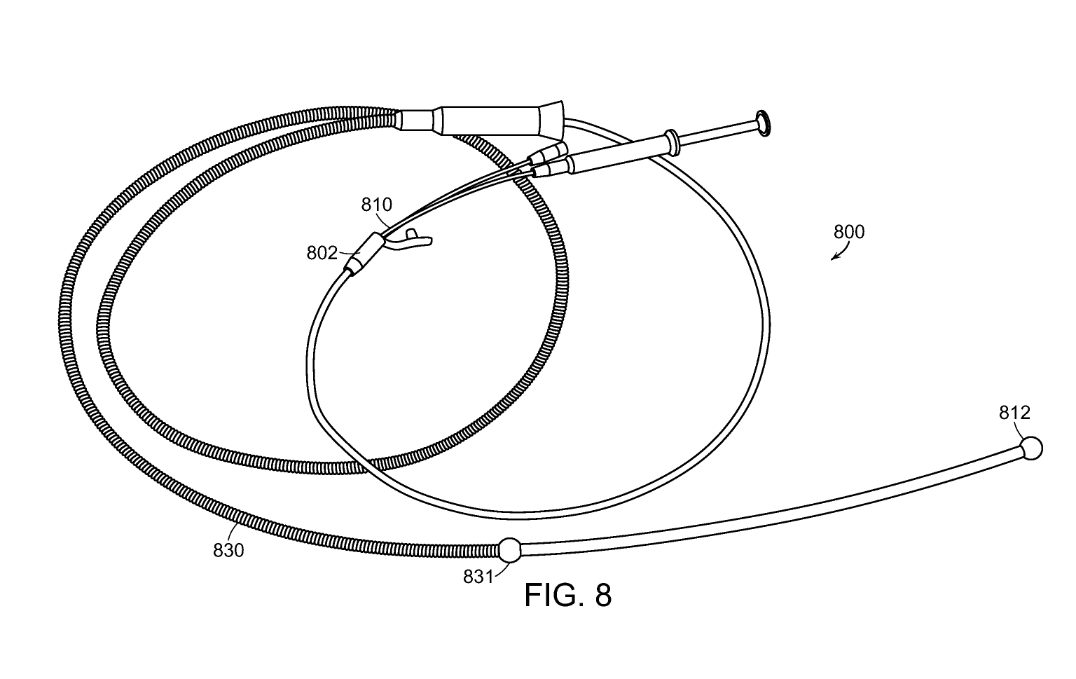

FIG. 8 is a perspective view of a delivery system 800 including a releasable ball 812 at the tip of a catheter that can be pre-loaded within a custom naso-gastric (NG) tube 802 for delivery through the mouth. This embodiment is similar to the above described delivery systems, except that there is no size restriction of going through a PEG tube which, at its smallest ID, can be about 4 mm in diameter. The NG tube delivery system 800 may have a balloon tipped delivery catheter (see FIGS. 6A-6B) or a releasable ball tipped catheter (see FIGS. 1, 3A) and can be pre-loaded within a custom NG tube 802. On the outside of the NG tube 802 can be a long and, optionally, peel away introducer (outer sheath or guide tube) 830. The introducer 830 can be curved at the distal end to facilitate placement of the distal end of the introducer at or distal to the pylorus, e.g., in the bulbous duodenum. Once the introducer 830 is placed, the NG tube 802 is extended from the distal end of the introducer and into the intestine using the delivery catheter. The NG tube is typically used for enteral feeding (tube feeding), but may also be used for removal of fluids from the digestive system.

As shown in FIG. 8, the introducer 830 can be a corrugated tube and may have a helical corrugation pattern. A corrugated shape provides low friction between the introducer 830 and the NG tube 802, which facilitates passing of the NG tube through the introducer and removing the introducer when pulled back over the NG tube. In addition, the corrugated shape improves the ability of the user to steer the introducer into the intestine. The introducer may optionally include an atraumatic element 831 at its distal end as shown in FIG. 8.

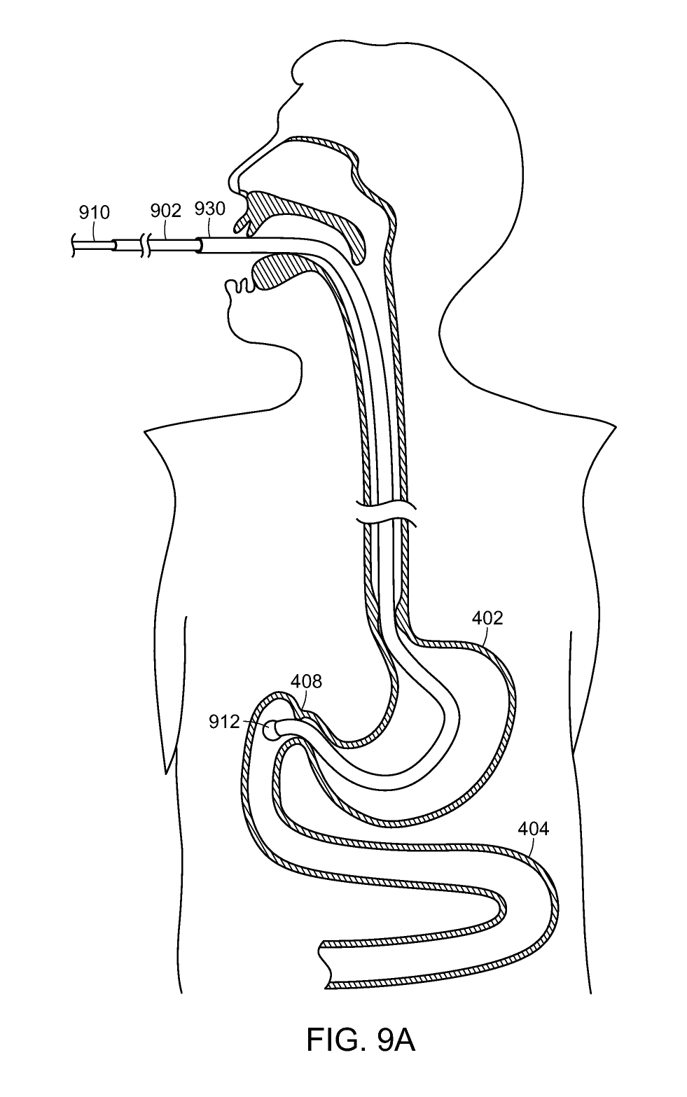

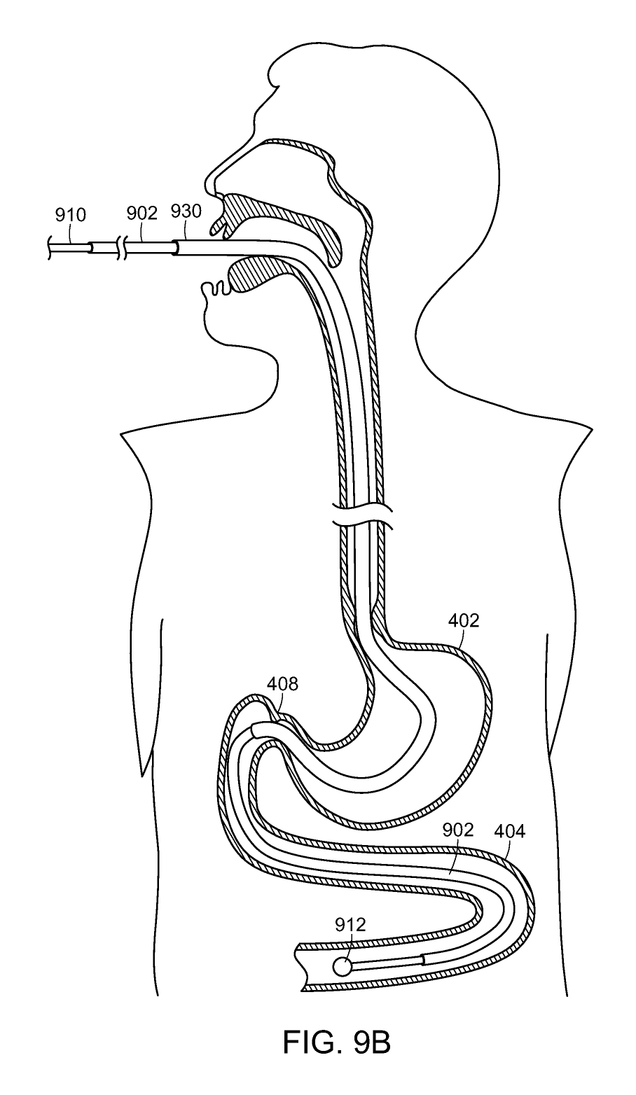

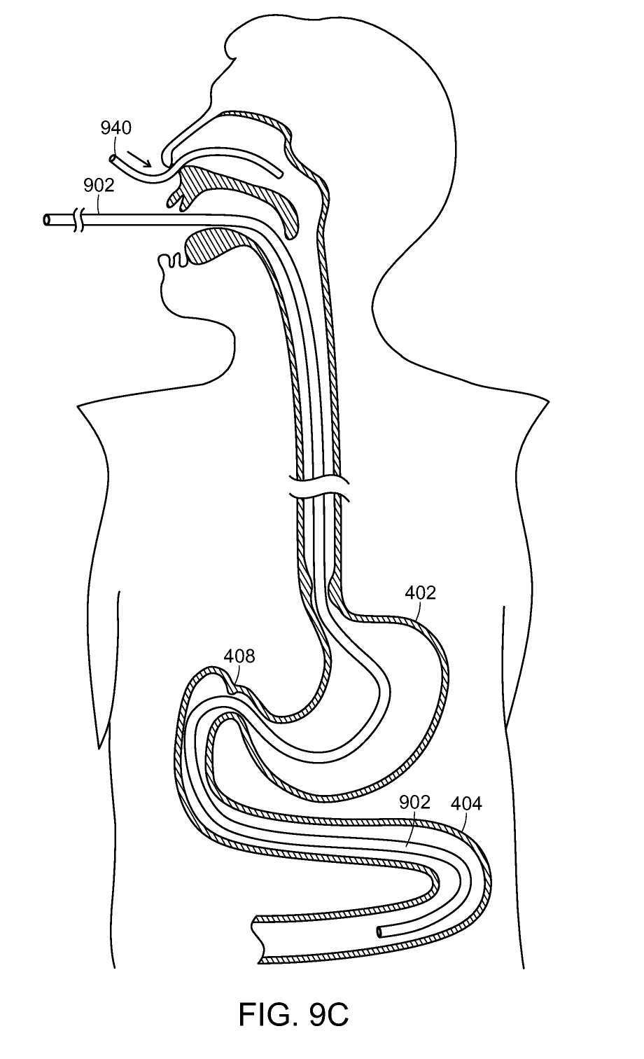

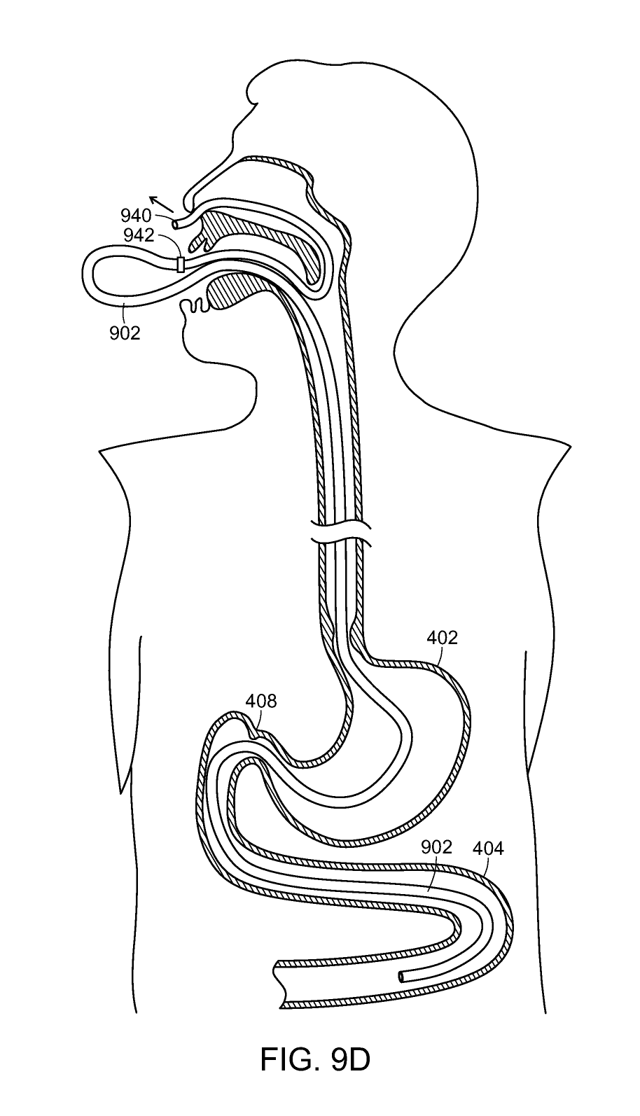

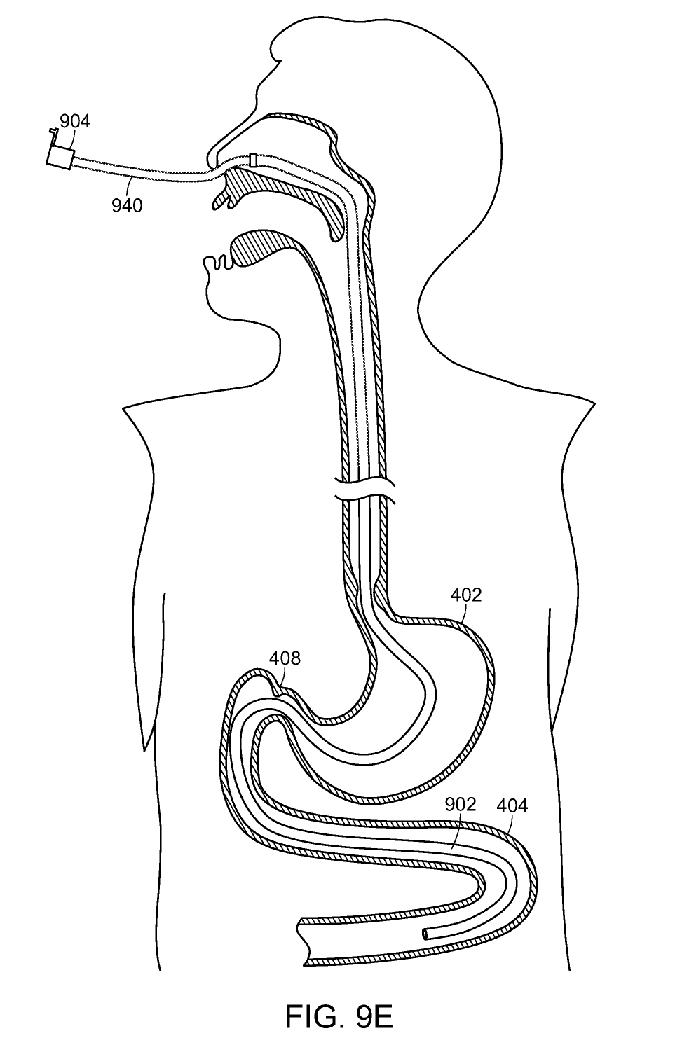

FIGS. 9A-9E illustrate delivery of a custom NG tube through the mouth using a delivery system, such as described with reference to FIG. 8. The system includes an inner catheter or shaft 910, a delivery tube (NG tube) 902, an atraumatic element 912 coupled to the distal end of the inner catheter, and an outer sheath or introducer 930. The system is placed trans-orally in the digestive tract (FIG. 9A). Using the introducer 930, the system can be steered through the stomach 402 and towards the pylorus 408, the atraumatic element 912 leading the introducer and inner catheter as the system passes through the alimentary canal. Once the distal end of the introducer 930 is in place at the desired location in the digestive tract, the inner catheter 910 and the NG tube 902 can be extended distally into the digestive tract (FIG. 9B). As shown in FIG. 9B, the distal end of the introducer 930 is placed at the pylorus 408 and the inner catheter 910 and NG tube 902 are extended into the intestine 404, e.g. into the jejunum. The inner catheter 910 may be extended first and the NG tube 902 second, the NG tube sliding over the extended inner catheter. When the inner catheter 910 and the NG tube 902 are extended to the desired location in the digestive tract, the atraumatic element 912 can be released or deflated and the inner delivery catheter 910 can be removed. The outer sheath or introducer 930 can be removed, e.g., pulled back over the NG tube 902 or, optionally, peeled away, leaving a patent tube 902 from the mouth to the jejunum (FIG. 9C). The user can then place a short tube 940 through the nose and into the back of the mouth (FIG. 9C) and pull the free end of the tube 940 out orally. Tube 940 can be of the same diameter as the tube 902 coming from the mouth. A connection 942 can be provided to connect the free end of the short tube 940 to the free (proximal) end of the delivery tube 902 to complete the NG tube (FIG. 9D). Alternatively, the user may insert an instrument, e.g., a grasper, through the nose and into the back of the mouth to grasp the proximal end (free end) of the tube 902 and pull the tube 902 out through the nose. A cap or port 904 can be connected to the proximal end of the NG tube after the tube is in place (FIG. 9E).

Scenario 4: Using a Stylet and a GI Dynamics Delivery System for Delivering a Feeding Tube Through a PEG Tube

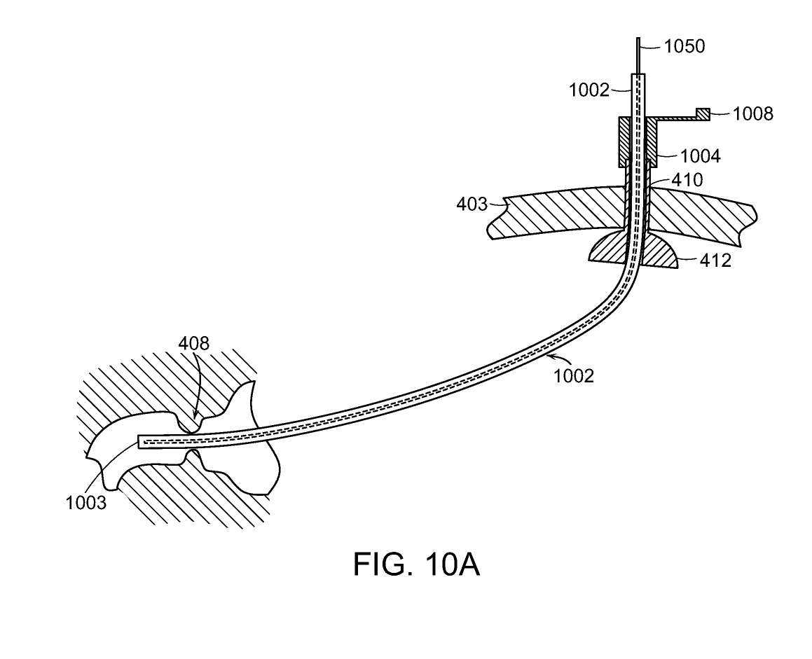

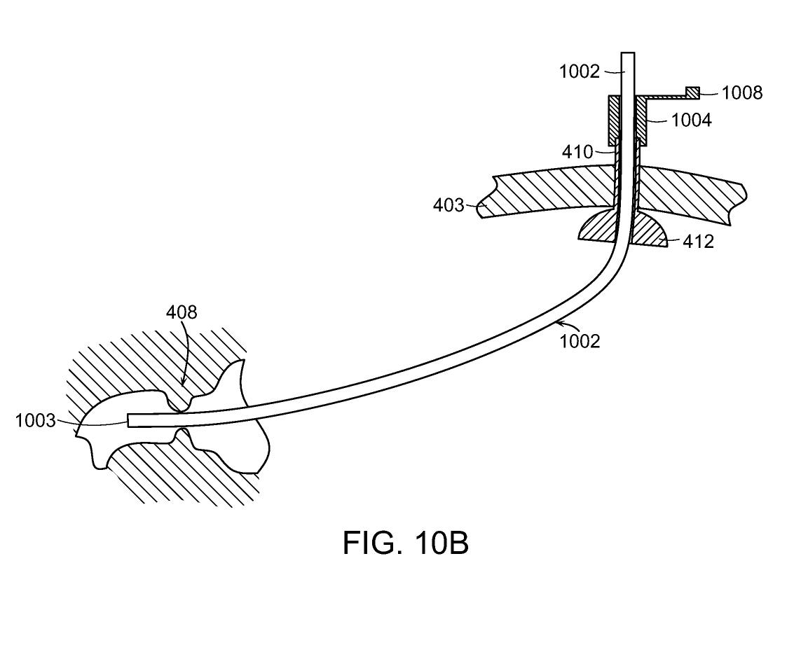

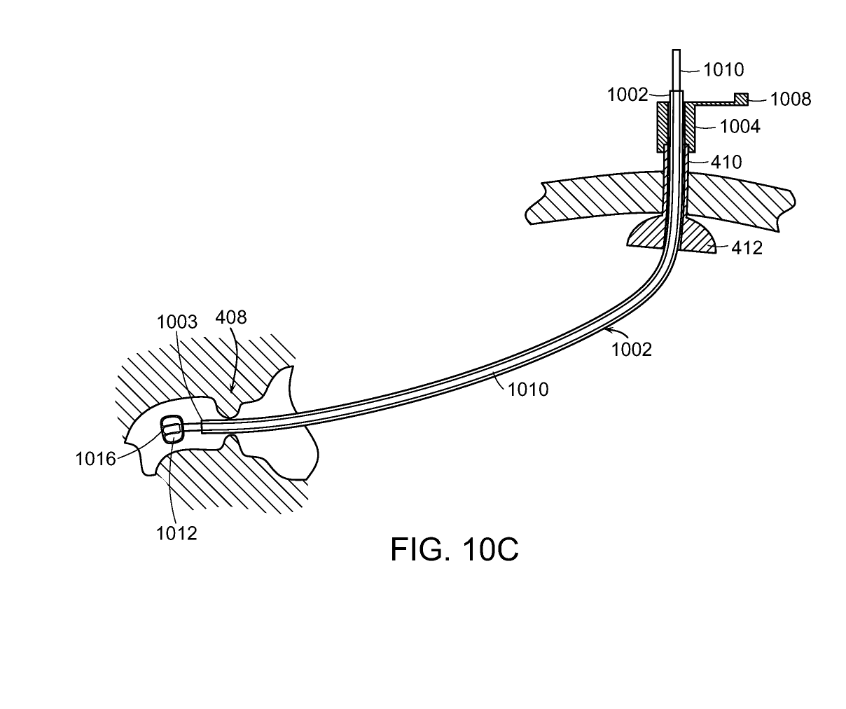

Instead of an outer sheath or introducer, a stylet may be used to steer a gastrointestinal device through a length of the stomach. FIGS. 10A-10C illustrate delivery of a delivery tube 1002 (e.g., a J-tube) through a percutaneous port 410 (e.g., a PEG tube 412) using a stylet 1050. The stylet can be a stiff stylet and can be configured to fit through a lumen of a standard delivery tube, e.g., a J-tube 1002 or GJ-tube. The delivery tube 1002 includes or is coupled to a cap 1004 having a cover 1008. As shown in FIG. 1 OA, the stylet 1050 is inserted into a lumen of a J-tube. The J-tube 1002 and stylet 1050 are then inserted through the PEG tube 412 and the stylet is used to guide the J-tube through the stomach towards the pylorus 408. As shown, the stylet 1050 may be used to place the distal end 1003 of the J-tube at or distal to the pylorus 408. Advantageously, the stylet can be pre-curved, e.g., bent at the distal end, to enable a user to more easily aim the distal end 1003 of the delivery tube 1002 toward the pylorus 408.

As shown in FIG. 10B, the stylet is then removed leaving the J-tube 1002 in place. Next, one can use a GI Dynamics delivery system having an inner catheter 1010 with an inflatable atraumatic element 1012, e.g., balloon tip, to deliver the J-tube 1002 further into the digestive system. As shown in FIG. 10C, the inner catheter 1010 and atraumatic element 1012 are inserted through the lumen of the J-tube 1002. Once the distal end of the inner catheter is extended past the distal end of the J-tube, the balloon 1012 is inflated. The inner catheter 1010 and J-tube 1002 can then be advanced together through the digestive tract with the atraumatic element 1012 leading the inner catheter and J-tube. Alternatively, the inner catheter 1010 may be advanced first and the J-tube 1002 second, the J-tube sliding over the inner catheter toward the distal end 1016 of the catheter. Once the J-tube is placed at the desired location in the digestive tract, e.g., in the jejunum, the balloon is deflated and the inner catheter 1010 is removed through the J-tube. The J-tube can be coupled to the percutaneous port 410, e.g., the PEG tube 412, as described above in reference to FIGS. 1 and 4F.

While this invention has been particularly shown and described with references to example embodiments thereof, it will be understood by those skilled in the art that various changes in form and details may be made therein without departing from the scope of the invention encompassed by the appended claims.

It should also be appreciated that the various features of the embodiments that have been described may be combined in various ways to produce numerous additional embodiments. Moreover, while various materials, dimensions, shapes, delivery locations, types of feeding tubes, etc. have been described for use with the disclosed embodiments, others besides those disclosed may be utilized without extending the scope of the invention, including delivery to locations in the stomach or the duodenum.

1. A delivery apparatus for delivering a gastrointestinal device, the apparatus comprising:
a gastrointestinal device having a lumen to provide a conduit into the digestive tract from a location external to the digestive tract, the device configured to extend through and couple to a port;
an inner shaft slidably disposed within the lumen of the gastrointestinal device and configured to pass through a length of the intestines and to deliver the gastrointestinal device; and
an atraumatic element distal to and coupled to a distal tip of the shaft.

2. (canceled)

3. The apparatus according to claim 1, wherein the atraumatic element is releasably coupled to the distal tip of the shaft, the shaft including a release mechanism that releasably engages the atraumatic element to retain the atraumatic element on the distal tip of the shaft.

4. (canceled)

5. The apparatus according to claim 3, wherein the atraumatic element is remotely releasable.

6. The apparatus according to claim 3, wherein the atraumatic element is attached to a loop which is held by the release mechanism.

7. The apparatus according to claim 3, wherein the release mechanism comprises a moveable element, the atraumatic element being released from the distal tip of the shaft and the moveable element by movement of the moveable element.

8. The apparatus according to claim 7, wherein the moveable element extends along a first lumen in the inner shaft and a pusher wire extends along a second lumen in the shaft, the pusher wire being moveable to push the atraumatic element, once released, away from the distal tip of the inner shaft.

9. The apparatus according to claim 7, wherein the inner shaft includes first and second holes near its distal tip, the moveable element exiting the shaft via the first hole and re-entering the shaft via the second hole.

10. The apparatus according to claim 9, wherein the moveable element extends between the first and second holes through a loop attached to the atraumatic element.

11. The apparatus according to claim 7, wherein the moveable element extends along a length of the inner shaft and is longitudinally moveable within the inner shaft.

12. The apparatus according to claim 7, wherein the moveable element is a wire.

13. The apparatus according to claim 7, wherein the atraumatic element is released by movement of the moveable element away from the atraumatic element.

14. The apparatus according to claim 1, wherein the inner shaft and gastrointestinal device are disposed within a curved outer sheath.

15. The apparatus according to claim 14, wherein the outer sheath guides the passage of the inner shaft and gastrointestinal device through a length of the stomach.

16. The apparatus according to claim 14, wherein the inner shaft, gastrointestinal device, and outer sheath are configured to pass through the port into the stomach.

17. The apparatus according to claim 1, wherein the port is a percutaneous port.

18. The apparatus according to claim 17, wherein the port comprises a percutaneous endoscopic gastrostomy (PEG) tube.

19. The apparatus according to claim 1, wherein the gastrointestinal device comprises a jejunal feeding tube.

20. The apparatus according to claim 1, wherein the atraumatic element comprises a ball.

21. The apparatus according to claim 1, wherein the atraumatic element is inflatable.

22. The apparatus according to claim 1, wherein the atraumatic element is substantially larger in diameter than the inner shaft.

23. The apparatus according to claim 22, wherein the atraumatic element is about 4 mm to about 12 mm in diameter and the inner shaft is about 2 mm to about 3 mm in diameter.

24. The apparatus according to claim 1, wherein the atraumatic element includes a hydrogel that expands in place in the stomach.

25. The apparatus according to claim 1, wherein the inner shaft is a catheter having a lumen therein.

26. The apparatus according to claim 1, wherein the inner shaft has a minimum bend radius of less than 0.5 inches without kinking.

27. A delivery apparatus for delivering a delivery tube, the apparatus comprising:
a delivery tube having a lumen to provide a conduit into the digestive tract from a location external to the digestive tract;
an inner shaft slidably disposed within the lumen of the delivery tube and configured to pass through a length of the intestines and to deliver the delivery tube;
an atraumatic element distal to and coupled to a distal tip of the shaft; and
an outer sheath, the inner shaft and delivery tube being disposed within the outer sheath.

28. (canceled)

29. The apparatus according to claim 27, wherein the atraumatic element is releasably coupled to the distal tip of the shaft, the shaft including a release mechanism that releasably engages the atraumatic element to retain the atraumatic element on the distal tip of the shaft.

30. The apparatus according to claim 27, wherein the atraumatic element is inflatable.

31. The apparatus according to claim 27, wherein the atraumatic element is a ball.

32. The apparatus according to claim 27, wherein the outer sheath is configured for delivery through the mouth.

33. A delivery apparatus for delivering a gastrointestinal device, the apparatus comprising:
a gastrointestinal device having a lumen to provide a conduit into the digestive tract from a location external to the digestive tract;
a stylet removably disposed within the lumen to guide passage of the gastrointestinal device through a length of the stomach;
an inner shaft extendable through the lumen of the gastrointestinal device when the stylet is removed and configured to pass through a length of the intestines and to deliver the gastrointestinal device; and
an atraumatic element distal to and coupled to a distal tip of the shaft.

34. (canceled)

35. The apparatus according to claim 33, wherein the gastrointestinal device is configured to extend through and couple to a port.

36. The apparatus according to claim 35, wherein the port comprises a percutaneous endoscopic gastrostomy (PEG) tube.

37. The apparatus according to claim 33, wherein the gastrointestinal device comprises a jejunal feeding tube.

38. The apparatus according to claim 33, wherein the atraumatic element is inflatable.

39. The apparatus according to claim 33, wherein the stylet is curved to guide the gastrointestinal device toward the pylorus.

40. A method of delivering a gastrointestinal device, the method comprising:
passing an inner shaft through a port through a length of the intestines, the shaft having an atraumatic element distal to and coupled to a distal tip of the shaft;
advancing a gastrointestinal device over the inner shaft toward the distal tip of the inner shaft;
withdrawing the inner shaft; and
securing the gastrointestinal device to the port, the gastrointestinal device having a lumen to provide a conduit into the digestive tract from a location external to the digestive tract.

41. The method according to claim 40, wherein the atraumatic element is releasably coupled to the distal tip of the shaft, the shaft including a release mechanism that releasably engages the atraumatic element to retain the atraumatic element on the distal tip of the shaft, and further comprising releasing the atraumatic element from the inner shaft and the release mechanism within the intestines.

42. A method of delivering a delivery tube, the method comprising:
passing an inner shaft through an outer sheath through a length of the intestines, the shaft having an atraumatic element distal to and coupled to a distal tip of the shaft;
advancing a delivery tube over the inner shaft toward the distal tip of the inner shaft, the delivery tube having a lumen to provide a conduit into the digestive tract from a location external to the digestive tract;
withdrawing the inner shaft through the lumen of the delivery tube; and
withdrawing the outer sheath.

43. The method according to claim 42, wherein the atraumatic element is releasably coupled to the distal tip of the shaft, the shaft including a release mechanism that releasably engages the atraumatic element to retain the atraumatic element on the distal tip of the shaft, and further comprising releasing the atraumatic element from the inner shaft and the release mechanism within the intestines.

44. A method of delivering a gastrointestinal device, the method comprising:
passing a gastrointestinal device and a stylet through a length of the stomach, the gastrointestinal device having a lumen to provide a conduit into the digestive tract from a location external to the digestive tract, the stylet being removably disposed with the lumen;
removing the stylet;
extending an inner shaft through the lumen of the gastrointestinal device through a length of the intestines, the shaft having an atraumatic element distal to and coupled to a distal tip of the shaft;
advancing the gastrointestinal device over the inner shaft toward the distal tip of the inner shaft; and
withdrawing the inner shaft.
